(19) United States
(12) Patent Application Publication
(10) Pub. No.: US 2009/0293081 A1
(43) Pub. Date: Nov. 26, 2009

(54) METHODS AND COMPUTER PROGRAM PRODUCTS FOR PERFORMING SEARCHES AT A PLURALITY OF CONTENT STORING LOCATIONS

(75) Inventors: Akbar Pirani, Marietta, GA (US); Jerry Liu, Atlanta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/125,383

(22) Filed: May 22, 2008

(51) Int. Cl. H04N 7/16; G06F 17/30

(52) U.S. Cl. 725/25; 707/3

(57) ABSTRACT

Locating content by performing a search at a plurality of content storing locations is provided. A search query is received requesting content. A search is performed for the requested content at a plurality of content storing locations including at least a user content storage device and a network accessible content storage device. If the search locates the requested content, and if the requested content is not stored on the user content storage device, then digital rights management protection is applied to the requested content and the requested content is streamed from the network accessible content storage device to the user content storage device. Digital rights management protection denies access to the requested content until a payment authorization is received.

### BACKGROUND

Exemplary embodiments relate generally to computer-implemented content searching and, more particularly, to methods and computer program products for performing searches at a plurality of content storing locations.

From time to time, an individual may wish to locate electronically stored content such as a movie, musical selection, video program, or knowledge about a specific topic. With the explosive outgrowth of content distribution systems such as cable, satellite, online video rental companies, internet protocol television (IPTV), and video on demand (VOD), it may be difficult to locate a desired item of content. For example, if an individual subscribes to a first content distribution system, one or more desired items of content may not be available on the system. A second content distribution system may include these items, but the individual must subscribe to the second system in order to gain access to the items. Although one could subscribe to a multiplicity of different systems in order to gain access to a broad selection of content, the cost of doing so may be prohibitive.

Content distribution systems may include search engines, but these engines are only equipped to search for content stored on that system. For example, an online search engine provided by online video rental company Netflix™ will not inform users as the availability of an item from Blockbuster™. Consequently, it may be necessary to repeat similar searches across a multiplicity of different content distribution systems in order to locate a desired item. If one wishes to locate a particular movie, it may be necessary to initiate a first search using a first video rental company database, followed by a second search using a second video rental company database, and perhaps a third search using a database of video on demand titles. Similarly, if one is looking for knowledge or information about a specific topic, it may be necessary to initiate a first search for instructional videos available from a video on demand service, a second search for electronic books available for downloading from a website, and a third search for instructional programs available from a provider of satellite programming. Implementing a multiplicity of search queries to locate a desired item is inefficient and time consuming.

In view of the aforementioned shortcomings, it would be desirable to formulate a fast, efficient, and convenient approach for locating content that may be electronically stored at any of a plurality of content distribution systems.

### BRIEF SUMMARY

Exemplary embodiments relate to methods of locating content by performing a search at a plurality of content storing locations. A search query is received requesting content. A search is performed for the requested content at a plurality of content storing locations including at least a user content storage device and a network accessible content storage device. If the search locates the requested content, and if the requested content is not stored on the user content storage device, then digital rights management protection is applied to the requested content and the requested content is streamed from the network accessible content storage device to the user content storage device. Digital rights management protection denies access to the requested content until a payment authorization is received.

Additional exemplary embodiments relate to methods of automatically locating content for a user. One or more user preferences for stored content are received, or user preferences for stored content are determined based upon content that the user has accessed in the past. Based upon received user preferences or determined user preferences or both, a search is performed for stored content at a plurality of content storing locations including at least a user content storage device and a network accessible content storage device. If the search locates the requested content, and if the requested content is not stored on the user content storage device, then digital rights management protection is applied to the requested content and the requested content is streamed from the network accessible content storage device to the user content storage device. Digital rights management protection denies access to the requested content until a payment authorization is received.

Additional exemplary embodiments include computer program products comprising a storage medium readable by a processing circuit and storing instructions for execution by the processing circuit for facilitating a method of locating content by performing a search at a plurality of content storing locations. The method includes receiving a search query for requested content. A search is performed for the requested content at a plurality of content storing locations including at least a user content storage device and a network accessible content storage device. If the search locates the requested content, and if the requested content is not stored on the user content storage device, then digital rights management protection is applied to the requested content and the requested content is streamed from the network accessible content storage device to the user content storage device. Digital rights management protection denies access to the requested content until a payment authorization is received.

Additional exemplary embodiments include computer program products comprising a storage medium readable by a processing circuit and storing instructions for execution by the processing circuit for facilitating a method of automatically locating content for a user. The method includes receiving one or more user preferences for stored content, or determining user preferences for stored content based upon content that the user has accessed in the past. Based upon received user preferences or determined user preferences or both, a search is performed for stored content at a plurality of content storing locations including at least a user content storage device and a network accessible content storage device. If the search locates the requested content, and if the requested content is not stored on the user content storage device, then digital rights management protection is applied to the requested content and the requested content is streamed from the network accessible content storage device to the local content storage device. Digital rights management protection denies access to the requested content until a payment authorization is received.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for locating content by performing searches at a plurality of content storing locations.

FIGS. 2A-2C together comprise a flow diagram of an exemplary process for locating content by performing searches at a plurality of content storing locations.

FIGS. 3A-3C together comprise a flow diagram of an exemplary process for automatically locating content for a user.

The detailed description explains the exemplary embodiments, together with advantages and features, by way of example with reference to the drawings.

### DETAILED DESCRIPTION OF EXEMPLARY EMBODIMENTS

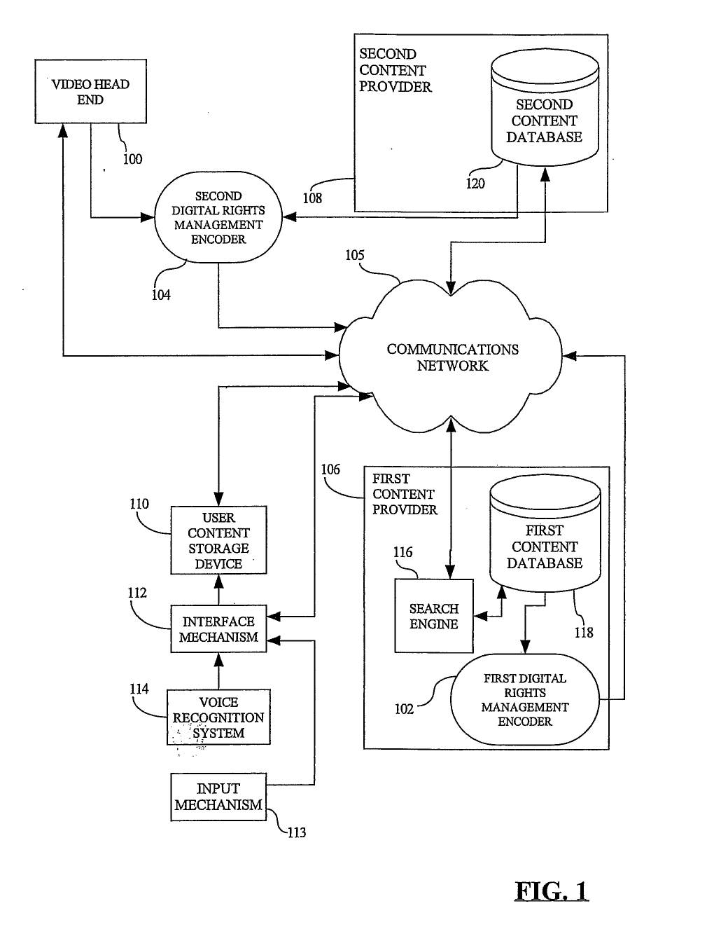

FIG. 1 is a block diagram of an exemplary system that may be utilized for locating content by performing searches at a plurality of content storing locations. A communications network 105 is illustratively implemented using the Internet, a private intranet, a public switched telephone network (PSTN), a cable television network, or any of various combinations thereof. A user content storage device 110 represents any device that includes a computer readable data storage drive for storing content such as video programs, movies, audio programs, games, documents, content retrieved from the Internet, or any other type of electronically storable content. The user content storage device 110 includes a processing mechanism, operatively coupled to the computer readable data storage drive, for storing content in the computer readable data storage drive, and for retrieving content from the computer readable data storage drive in accordance with a digital rights management algorithm, as will be described in greater detail hereinafter. User content storage device 110 also includes a communications mechanism, operatively coupled to the processing mechanism, for initiating electronic communication over communications network 105. Illustratively, user content storage device 110 may be implemented using a digital video recorder (DVR), a computer hard drive, an IPOD device, a personal digital assistant (PDA), or any of various combinations thereof Illustratively, user content storage device 110 is implemented using a high-capacity DVR providing one terabyte (TB) or more of storage space.

User content storage device 110 is capable of storing content received from one or more content providers over communications network 105. In the illustrative example of FIG. 1, these content providers include a first content provider 106, a second content provider 108, and a video head end 100, although any number of one or more content providers may be provided. First content provider 106 includes a first content database 118, and second content provider 108 includes a second content database 120. First content provider 106 represents any provider of electronic content, such as an online video rental company, an Internet website, a remote server, a cable television outlet, or a provider of satellite programming. Similarly, second content provider 108 represents any provider of electronic content, such as an online video rental company, an Internet website, a remote server, a cable television outlet, or a provider of satellite programming. Video head end 100 may represent a cable television or satellite head end capable of providing one or more real time television broadcasts, or video on demand programs, or both, to user content storage device 110 over communications network 105.

First content database 118 stores content on a computer readable storage medium. This content illustratively includes one or more movies, video programs, audio programs, documents, games, or information. Likewise, second content database 120 stores content on a computer readable storage medium, wherein this content illustratively includes one or more movies, video programs, audio programs, documents, games, or information. First content database 118 may, but need not, include content not present in second content database 120. Similarly, second content database 120 may, but need not, include content not present in first content database 118. First content database 118 and second content database 120 could each be implemented, for example, using one or more computer servers.

User content storage device 110 is operatively coupled to an interface mechanism 112 capable of accepting inputs from a user. User inputs are accepted to initiate a search query for content, to store any content located by the search on user content storage device 110, and to provide subsequent access to the stored content. For example, interface mechanism 112 may be equipped to accept voice commands received by a voice recognition system 114. Alternatively or additionally, the interface mechanism 112 can accept the search query from an input mechanism 113 such as a keyboard or a touch screen, for example. Interface mechanism 112 is operatively coupled to a search engine 116 capable of accepting one or more search queries for content. In this manner, a user can verbalize a search query, whereupon the query is received by voice recognition system 114 and converted into an electronic search query by interface mechanism 112. Interface mechanism 112 then transmits the electronic search query to search engine 116.

Search engine 116 is capable of searching for content stored on first content database 118, second content database 120, video head end 100, and user content storage device 110. In the present example, search engine 116 is provided by first content provider 106 for purposes of illustration. Alternatively or additionally, search engine 116 could be provided by second content provider 108, video head end 100, user content storage device 110, or an entity accessible over communications network 105, such as an Internet web site or a computer server. Alternatively or additionally, search engine 116 may be implemented using a federated or collaborative search engine such that a main search engine issues search requests to other search engines at various locations. If search engine 116 is provided by user content storage device 110, then the processing mechanism of user content storage device 110 is capable of issuing search queries to remote databases (such as second content database 120) over communications network 105. Pursuant to the present example, search engine 116 accesses second content database 120, video head end 100, and user content storage device 110 over communications network 105.

If search engine 116 locates desired content in response to a search query, this content may be located on any of a plurality of storage devices. These storage devices may include user content storage device 110 or another storage device that is accessible over communications network 105, such as first content database 118, second content database 120, or video head end 100. According to exemplary embodiments, if the desired content is located on a storage device other than user content storage device 110, a digital rights management algorithm is applied to the content, and the content is then downloaded to user content storage device 110. For example, if the desired content is located on first content database 118, a first digital rights management encoder 102 applies digital rights management protection to the content before the content is downloaded by first content provider 106 over communications network 105 to user content storage device 110. Similarly, if the desired content is located on second content database 120 or video head end 100, a second digital rights management encoder 104 applies digital rights management protection to the content before the content is downloaded over communications network 105 to user content storage device 110. In accordance with exemplary embodiments, the digital rights management protection applied by first and second digital rights management encoders 102, 104 denies access to the requested content until a payment authorization is received. Accordingly, digital rights management protection prevents a user from accessing content downloaded to and stored on user content storage device 110 until the user indicates a willingness to pay for the content. Once the user indicates an intention to pay for the protected content, digital rights management protection enables access to the protected content.

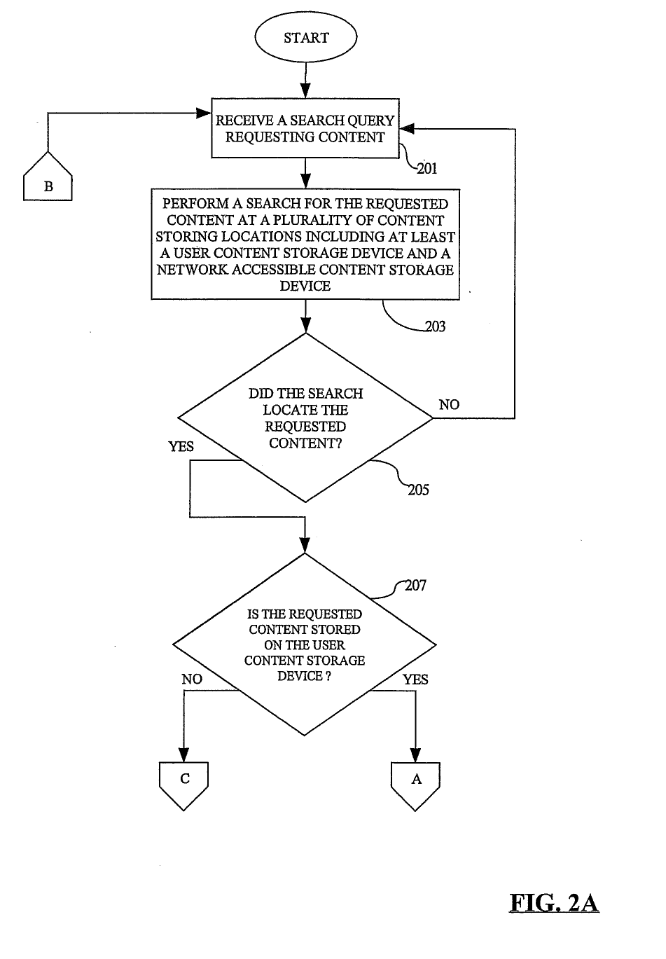

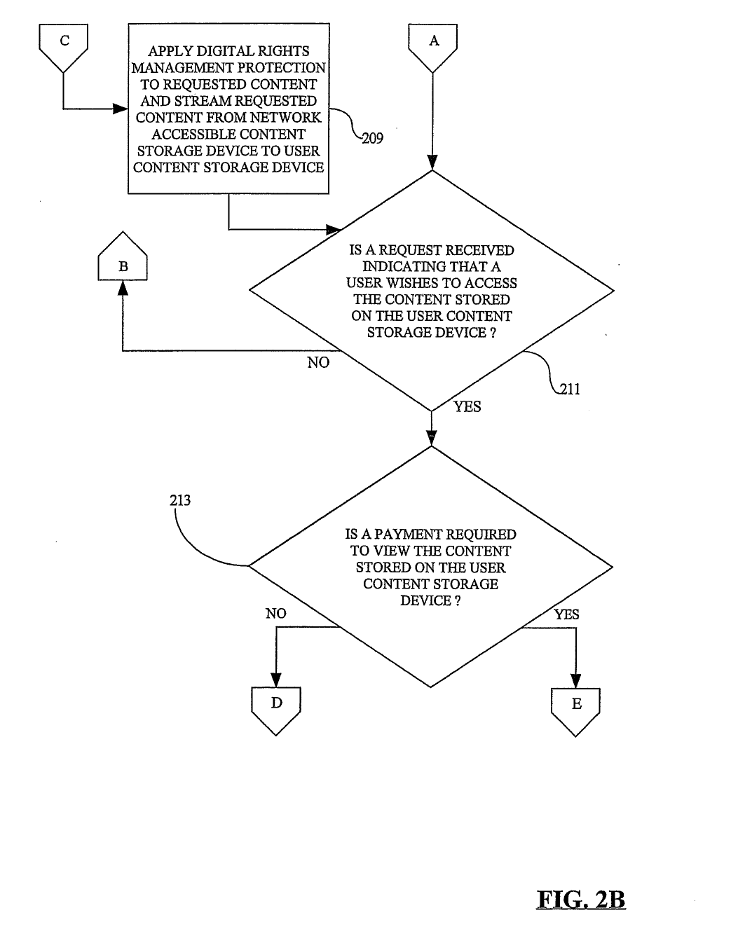

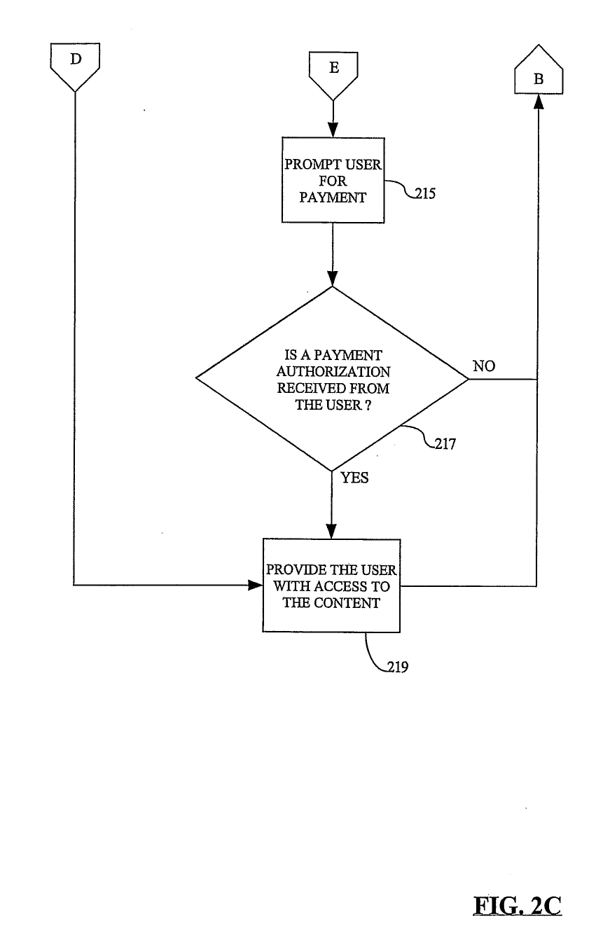

FIGS. 2A-2C together comprise a flow diagram of an exemplary process for locating content by performing searches at a plurality of content storing locations. The procedure commences at block 201 (FIG. 2A) where a search query is received, which requests content. Illustratively, this search query may include parameters indicative of a name of a movie, television program, or musical selection; a name of an artist, author, or musician; a topic for which further information is desired; a genre of movies, books, television programs, audio programs, or music; a date or range of dates for desired content; or various combinations thereof.

At block 203, a search is performed for the requested content at a plurality of content storing locations including at least user content storage device 110 (FIG. 1) and a network accessible content storage device (such as one or more of: first content database 118, second content database 120, or video head end 100). Next, at block 205 (FIG. 2A), a test is performed to ascertain whether or not the search located the requested content. If not, the program loops back to block 201. Optionally, before the program loops back to block 201, the content provider can create and/or add content to the network accessible content storage device based upon the search. The affirmative branch from block 205 leads to block 207 where a test is performed to ascertain whether or not the requested content is stored on the user content storage device 110. If the requested content is not stored on the user content storage device 110, then digital rights management protection is applied to the requested content and the requested content is streamed from the network accessible content storage device to the user content storage device (FIG. 2B, block 209). Alternatively, before streaming the content, the user can be provided with a menu option specifying whether or not streaming will be initiated. Alternatively or additionally, digital media can be sent to the user via regular mail or means other than streaming, wherein the media can be loaded onto the user content storage device 110. As stated above, this digital rights management protection may be applied by first digital rights management encoder 102 or second digital rights management encoder 104 (FIG. 1). Digital rights management protection denies access to the requested content until a payment authorization is received. The procedure then progresses to block 211 (FIG. 2B).

The affirmative branch from block 207 (FIG. 2A) leads to block 211 (FIG. 2B). Block 211 may also be performed after block 209 has been performed. At block 211, a test is performed to ascertain whether or not a request has been received indicating that a user wishes to access the content stored on the user content storage device. If not, the program loops back to block 201 (FIG. 2A). The affirmative branch from block 211 (FIG. 2B) leads to block 213 where a test is performed to ascertain whether or not a payment is required to access the content stored on the user content storage device. If not, the user is provided with access to the content (FIG. 2C, block 219), and the procedure loops back to block 201 (FIG. 2A).

The affirmative branch from block 213 (FIG. 2B) leads to block 215 (FIG. 2C) where the user is prompted for payment. At block 217, a test is performed to ascertain whether or not a payment authorization has been received from the user. If not, the procedure loops back to block 201 (FIG. 2A). The affirmative branch from block 217 (FIG. 2C) leads to block 219 where the user is provided with access to the content. The procedure then loops back to block 201 (FIG. 2A).

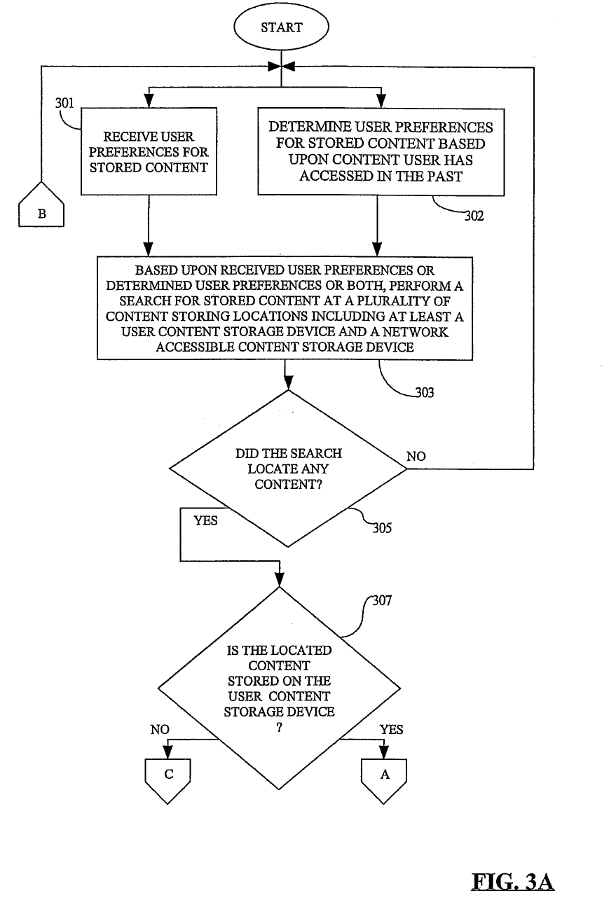

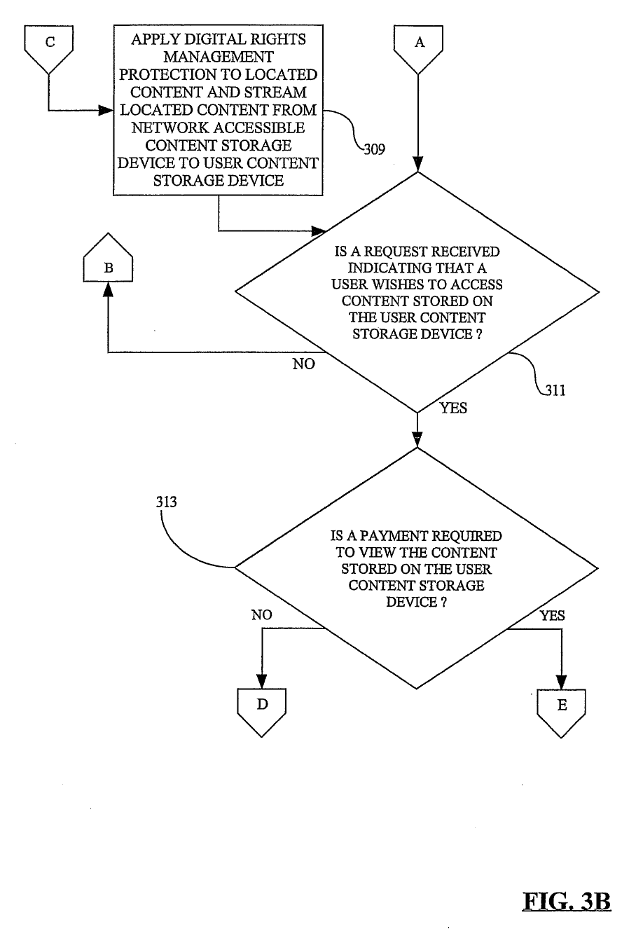

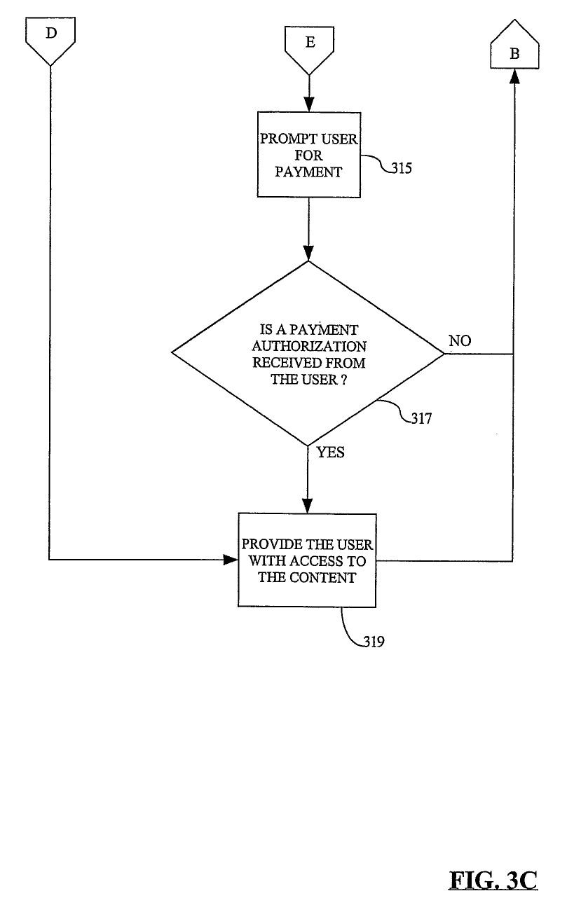

FIGS. 3A-3C together comprise a flow diagram of an exemplary process for automatically locating content for a user. The procedure commences at any of blocks 301 or 302 (FIG. 3A). Only one of blocks 301 and 302 needs to be performed, but if both blocks are performed, they can be performed simultaneously or in any order. At block 301, one or more user preferences are received for stored content. For example, user preferences for stored content may include parameters indicative of a name of a movie, television program, or musical selection; a name of an artist, author, or musician; a topic for which further information is desired; a genre of movies, books, television programs, audio programs, or music; a date or range of dates for desired content; or various combinations thereof At block 302, user preferences are determined for stored content based upon content that a user has accessed in the past. As stated above, these user preferences may include parameters indicative of a name of a movie, television program, or musical selection; a name of an artist, author, or musician; a topic for which further information is desired; a genre of movies, books, television programs, audio programs, or music; a date or range of dates for desired content; or various combinations thereof For example, if a user has viewed several Star Trek episodes over the past month, user preferences may be determined which specify science fiction programs or television serials from the sixties.

At block 303, based upon received user preferences or determined user preferences or both, a search is performed for stored content at a plurality of content storing locations including at least user content storage device 110 (FIG. 1) and a network accessible content storage device (such as one or more of: first content database 118, second content database 120, or video head end 100). Next, at block 305 (FIG. 3A), a test is performed to ascertain whether or not the search located any stored content. If not, the program loops back to block 301. Optionally, before the program loops back to block 301, the content provider can create and/or add titles to the network accessible content storage device based upon the determined user preferences, the received user preferences, the search, or various combinations thereof The affirmative branch from block 305 leads to block 307 where a test is performed to ascertain whether or not the located content is stored on the user content storage device 110. If the located content is not stored on the user content storage device 110, digital rights management protection is applied to the located content and the content is streamed from the network accessible content storage device to the user content storage device (FIG. 3B, block 309). As stated above, this digital rights management protection may be applied by first digital rights management encoder 102 or second digital rights management encoder 104 (FIG. 1). Digital rights management protection denies access to the content until a payment authorization is received. The procedure then progresses to block 311 (FIG. 3B).

The affirmative branch from block 307 (FIG. 3A) leads to block 311 (FIG. 3B). Block 311 may also be performed after block 309 has been performed. At block 311, a test is performed to ascertain whether or not a request has been received indicating that a user wishes to access the content stored on the user content storage device. If not, the program loops back to block 301 (FIG. 3A). The affirmative branch from block 311 (FIG. 3B) leads to block 313 where a test is performed to ascertain whether or not a payment is required to access the content stored on the user content storage device. If not, the user is provided with access to the content (FIG. 3C, block 319), and the procedure loops back to block 301 (FIG. 3A).

The affirmative branch from block 313 (FIG. 3B) leads to block 315 (FIG. 3C) where the user is prompted for payment. At block 317, a test is performed to ascertain whether or not a payment authorization has been received from the user. If not, the procedure loops back to block 301 (FIG. 3A). The affirmative branch from block 317 (FIG. 3C) leads to block 319 where the user is provided with access to the content. The procedure then loops back to block 301 (FIG. 3A).

As described heretofore, the exemplary embodiments can be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments execute specific microprocessor machine instructions. The computer program code could be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of locating content by performing a search at a plurality of content storing locations, the method comprising:
receiving a search query requesting content;
performing a search for the requested content at a plurality of content storing locations including at least a user content storage device and a network accessible content storage device; and
if the search locates the requested content, and if the requested content is not stored on the user content storage device, then applying digital rights management protection to the requested content for denying access to the requested content until a payment authorization is received, and downloading the requested content from the network accessible content storage device to the user content storage device.

2. The method of claim 1 further comprising storing the search query.

3. The method of claim 2 further comprising using the stored search query to perform a search for the requested content on a repeated, periodic, or scheduled basis.

4. The method of claim 1 further including receiving the search query using voice recognition.

5. The method of claim 1 further comprising performing a search for the requested content at a video head end capable of providing any of a plurality of television broadcasts.

6. The method of claim 1 wherein the content provider adds or creates the requested content on the network accessible content storage device.

7. A computer program product comprising a storage medium readable by a processing circuit and storing instructions for execution by the processing circuit for facilitating a method of locating content by performing a search at a plurality of content storing locations, the method comprising:
receiving a search query requesting content;
performing a search for the requested content at a plurality of content storing locations including at least a user content storage device and a network accessible content storage device; and
if the search locates the requested content, and if the requested content is not stored on the user content storage device, then applying digital rights management protection to the requested content for denying access to the requested content until a payment authorization is received, and downloading the requested content from the network accessible content storage device to the user content storage device.

8. The computer program product of claim 7 further comprising instructions for storing the search query.

9. The computer program product of claim 8 further comprising instructions for using the stored search query to perform a search for the requested content on a repeated, periodic, or scheduled basis.

10. The computer program product of claim 7 further including instructions for receiving the search query using voice recognition.

11. The computer program product of claim 7 further comprising instructions for performing a search for the requested content at a video head end capable of providing any of a plurality of television broadcasts.

12. A method of automatically locating content for a user by performing a search at a plurality of content storing locations, the method comprising:
receiving one or more user preferences for stored content, or determining one or more user preferences for stored content based upon content that the user has accessed in the past;
based upon received user preferences or determined user preferences or both, performing a search for stored content at a plurality of content storing locations including at least a user content storage device and a network accessible content storage device;
if the search locates the requested content, and if the requested content is not stored on the user content storage device, then applying digital rights management protection to the requested content for denying access to the requested content until a payment authorization is received, and downloading the requested content from the network accessible content storage device to the user content storage device.

13. The method of claim 12 further comprising storing the search query.

14. The method of claim 11 further comprising using the stored search query to perform a search for the requested content on a repeated, periodic, or scheduled basis.

15. The method of claim 12 further including receiving the search query using voice recognition.

16. The method of claim 15 further comprising performing a search for the requested content at a video head end capable of providing any of a plurality of television broadcasts.

17. A computer program product comprising a storage medium readable by a processing circuit and storing instructions for execution by the processing circuit for facilitating a method of automatically locating content for a user by performing a search at a plurality of content storing locations, the method comprising:
receiving one or more user preferences for stored content, or determining one or more user preferences for stored content based upon content that the user has accessed in the past;
based upon received user preferences or determined user preferences or both, performing a search for stored content at a plurality of content storing locations including at least a user content storage device and a network accessible content storage device;
if the search locates the requested content, and if the requested content is not stored on the user content storage device, then applying digital rights management protection to the requested content for denying access to the requested content until a payment authorization is received, and downloading the requested content from the network accessible content storage device to the user content storage device.

18. The computer program product of claim 17 further comprising instructions for storing the search query.

19. The computer program product of claim 18 further comprising instructions for using the stored search query to perform a search for the requested content on a repeated, periodic, or scheduled basis.

20. The computer program product of claim 17 further comprising instructions for performing a search for the requested content at a video head end capable of providing any of a plurality of television broadcasts or any of a plurality of video on demand programs or both.
